(19) United States
(12) Patent Application Publication
(10) Pub. No.: US 2025/0362844 A1
(43) Pub. Date: Nov. 27, 2025

(54) IMAGE FORMING APPARATUS, INFORMATION PROCESSING APPARATUS, CONTROL METHODS THEREOF, AND STORAGE MEDIUM

(71) Applicant: CANON KABUSHIKI KAISHA, Tokyo (JP)

(72) Inventors: YASUHIRO HOSODA, Kanagawa (JP); KYOHEI TAKEDA, Tokyo (JP)

(21) Appl. No.: 19/192,495

(22) Filed: Apr. 29, 2025

(30) Foreign Application Priority Data
May 22, 2024 (JP) 2024-083508

(51) Int. Cl. G06F 3/12; B41J 29/393; G03G 15/00

(52) U.S. Cl. CPC G06F 3/1222; G06F 3/1238; G06F 3/1288; B41J 29/393; G03G 15/5091

(57) ABSTRACT

An image forming apparatus includes a receiving unit configured to receive, from an information processing apparatus, authentication information of a user of the information processing apparatus, a requesting unit configured to request an authentication server to authenticate the user, an obtaining unit configured to obtain an attribute value of the user from the authentication server in a case where the user is successfully authenticated by the authentication server, and a setting unit configured to set a username of the user based on the attribute value in accordance with a setting rule selected from a plurality of setting rules.

### BACKGROUND OF THE INVENTION

### Field of the Invention

The present invention relates to an image forming apparatus, an information processing apparatus, control methods thereof, and a storage medium.

### Description of the Related Art

Authentication services having user authentication functions that centrally manage user accounts for organizations such as companies and schools are being provided in recent years. Some authentication services have a function for registering and managing personal computers in a company in units such as tenants or domains. For example, users registered with Microsoft's Microsoft Entra ID can log in to a personal computer running Windows using a user account managed by Microsoft Entra ID. Japanese Patent Laid-Open No. 2024-7209 describes an image forming apparatus that performs user authentication using an authentication service. When an information processing apparatus and an image forming apparatus have each performed user authentication using an authentication server, there may be cases where the username representing the user logged in to the information processing apparatus does not match the username representing the user logged in to the image forming apparatus. In such cases, the image forming apparatus may not be able to correctly associate the user logged in to the image forming apparatus with the user who submitted a print job to the image forming apparatus, which can cause inconvenience for the user.

### SUMMARY OF THE INVENTION

Some aspects of the present invention provide a technique for suppressing mismatches in usernames between an image forming apparatus and an information processing apparatus.

According to some embodiments, an image forming apparatus comprising: a receiving unit configured to receive, from an information processing apparatus, authentication information of a user of the information processing apparatus; a requesting unit configured to request an authentication server to authenticate the user; an obtaining unit configured to obtain an attribute value of the user from the authentication server in a case where the user is successfully authenticated by the authentication server; and a setting unit configured to set a username of the user based on the attribute value in accordance with a setting rule selected from a plurality of setting rules is provided.

Further features of the present invention will become apparent from the following description of exemplary embodiments with reference to the attached drawings.

### BRIEF DESCRIPTION OF THE DRAWINGS

FIG. 1 is a block diagram illustrating an example of the configuration of a system according to a first embodiment.

FIGS. 2A and 2B are block diagrams illustrating examples of the hardware of constituent elements of the system according to the first embodiment.

FIGS. 3A to 3C are block diagrams illustrating examples of the software of constituent elements of the system according to the first embodiment.

FIG. 4 is a schematic diagram illustrating an example of a settings page according to the first embodiment.

FIG. 5 is a schematic diagram illustrating an example of a settings page according to the first embodiment.

FIG. 6 is a schematic diagram illustrating an example of a settings page according to the first embodiment.

FIG. 7 is a schematic diagram illustrating an example of a settings page according to the first embodiment.

FIG. 8 is a schematic diagram illustrating an example of a properties screen according to the first embodiment.

FIG. 9 is a flowchart illustrating an example of a method for setting a username for a PC according to the first embodiment.

FIG. 10 is a flowchart illustrating an example of operations by a printer driver according to the first embodiment.

FIG. 11 is a flowchart illustrating an example of a method for logging in to an MFP according to the first embodiment.

FIG. 12 is a sequence chart illustrating an example of a setting rule synchronization method according to the first embodiment.

FIG. 13 is a schematic diagram illustrating an example of a settings screen according to a second embodiment.

FIG. 14 is a flowchart illustrating an example of operations in authenticated printing according to the second embodiment.

FIG. 15 is a flowchart illustrating an example of operations in authenticated printing according to the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### System Configuration

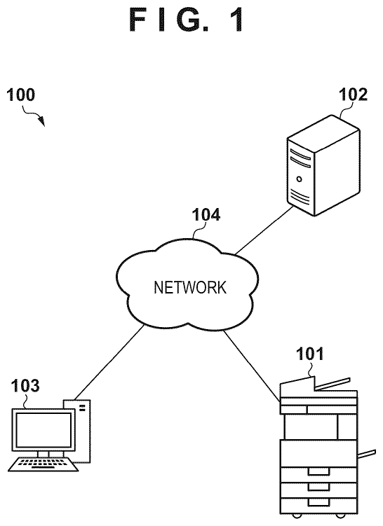

An example of the configuration of a system 100 according to a first embodiment will be described first with reference to FIG. 1. The system 100 includes a multifunction peripheral (MFP) 101, an authentication server 102, and a personal computer (PC) 103. Although FIG. 1 illustrates one each of the MFP 101, the authentication server 102, and the PC 103, the system 100 may include a plurality of MFPs 101, a plurality of authentication servers 102, and a plurality of PCs 103. The plurality of MFPs 101 included in the system 100 may have the same configuration, or may have different configurations. The same applies to the plurality of authentication servers 102 and the plurality of PCs 103.

The MFP 101 is an image forming apparatus having a plurality of main functions, such as copying, printing, scanning, and the like. The MFP 101 is an example of an image forming apparatus. The system 100 may include another image forming apparatus, such as a dedicated printer, for example, instead of the MFP 101. The following descriptions of the MFP 101 apply to such other image forming apparatuses as well.

The authentication server 102 is a device that provides an authentication service for authenticating users. The authentication server 102 may be constructed in a cloud environment. In this case, the authentication server 102 may be called a “cloud authentication server”, and the authentication service may be called a “cloud authentication service”.

The PC 103 is an example of an information processing apparatus. The system 100 may include another information processing apparatus, such as a smartphone, a tablet computer, or the like, for example, instead of the PC 103. The following descriptions of the PC 103 apply to such other information processing apparatuses as well. The PC 103 is used by a user to submit a print job to the MFP 101. The information processing apparatus may be called an “information processing terminal”, a “user apparatus”, a “user terminal”, or the like.

The MFP 101, the authentication server 102, and the PC 103 are capable of communicating with each other over a network 104. The network 104 may be the Internet, a local area network, a cellular network, a private network, another network, or any combination thereof.

### Hardware Configuration of MFP 101

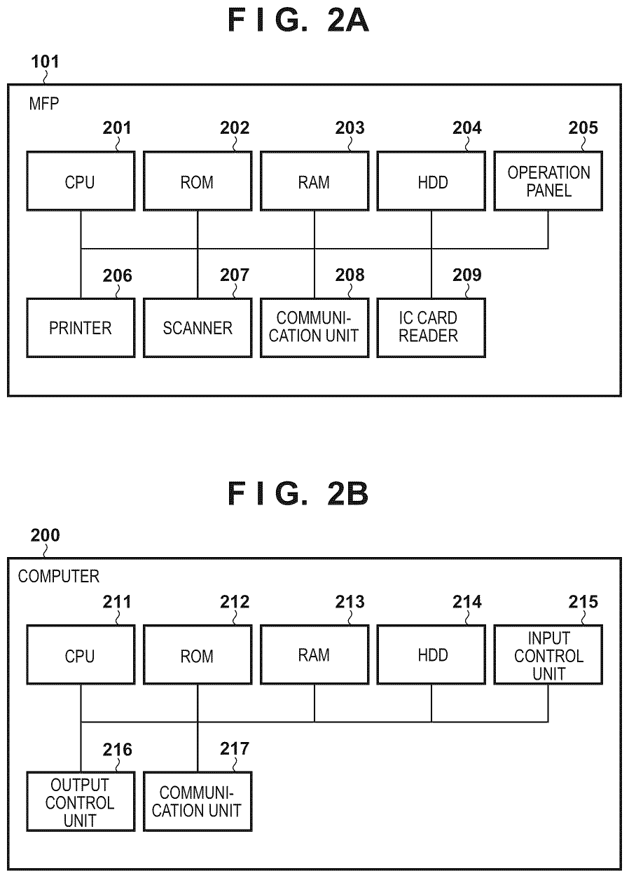

The hardware configuration of the MFP 101 will be described with reference to FIG. 2A. Some of the constituent elements illustrated in FIG. 2A may be omitted from the MFP 101, or the MFP 101 may include constituent elements not illustrated in FIG. 2A.

A central processing unit (CPU) 201 is a processor that controls the operations of the MFP 101 as a whole. The MFP 101 may include another processor, such as a microprocessor, instead of or in addition to the CPU 201. A read-only memory (ROM) 202 is a non-volatile memory. The ROM 202 stores a boot program and the like of the MFP 101. A random access memory (RAM) 203 is a volatile memory. The RAM 203 is used as a temporary storage region (a work area) for loading various types of control programs stored in the ROM 202 and a hard disk drive (HDD) 204.

The HDD 204 is a non-volatile storage device having a larger capacity than that of the RAM 203. The HDD 204 stores control programs, an operating system (OS), application programs, and the like of the MFP 101.

When the MFP 101 is started up, the CPU 201 executes the boot program stored in the ROM 202. The boot program specifies processing for reading out the OS stored in the HDD 204 and loading the OS into the RAM 203. The CPU 201 controls the MFP 101 by executing the OS loaded into the RAM 203 after the boot program is executed. The CPU 201 also reads out data used by the control program into the RAM 203.

Operations performed by the MFP 101 may be performed by the CPU 201 executing programs read out into the RAM 203. The CPU 201 may execute the programs cooperatively with other processors. At least some of the operations performed by the MFP 101 may be performed by a dedicated circuit such as an Application Specific Integrated Circuit (ASIC) or a Field-Programmable Gate Array (FPGA) (e.g., a hardware circuit).

An operation panel 205 is a display that can be operated by touch (i.e., a touch screen). A printer 206 is a device that prints print data received from an external apparatus through a communication unit 208, digital data obtained from a scanner 207, or the like. The scanner 207 is a device that generates digital data by reading a paper document.

The communication unit 208 is a network interface for connecting to the network 104. An integrated circuit (IC) card reader 209 is a device for reading out, from an IC card, information to be used in authentication.

### Hardware Configuration of Computer 200

The hardware configuration of a computer 200 will be described with reference to FIG. 2B. Some of the constituent elements illustrated in FIG. 2B may be omitted from the computer 200, or the computer 200 may include constituent elements not illustrated in FIG. 2B. The computer 200 may be used as the authentication server 102, or may be used as the PC 103. In the following descriptions, when used as the authentication server 102, the constituent elements of the computer 200 will be referred to simply as constituent elements of the authentication server 102 (e.g., a CPU 211 of the authentication server 102). The same applies for the PC 103.

The CPU 211, a ROM 212, a RAM 213, an HDD 214, and a communication unit 217 are the same as the CPU 201, the ROM 202, the RAM 203, the HDD 204, and the communication unit 208, respectively, and will therefore not be described again.

An input control unit 215 is an input interface that controls input devices of the computer 200, such as a mouse, a keyboard, a touchpad, and the like. The input control unit 215 obtains inputs made by the user using the input devices. The input devices may be devices external to the computer 200, or may be built into the computer 200.

An output control unit 216 is an output interface that controls output devices of the computer 200, such as a display, a speaker, and the like. The output control unit 216 controls the output devices so as to output information to the user. The output devices may be devices external to the computer 200, or may be built into the computer 200.

### Software Configuration of Authentication Server 102

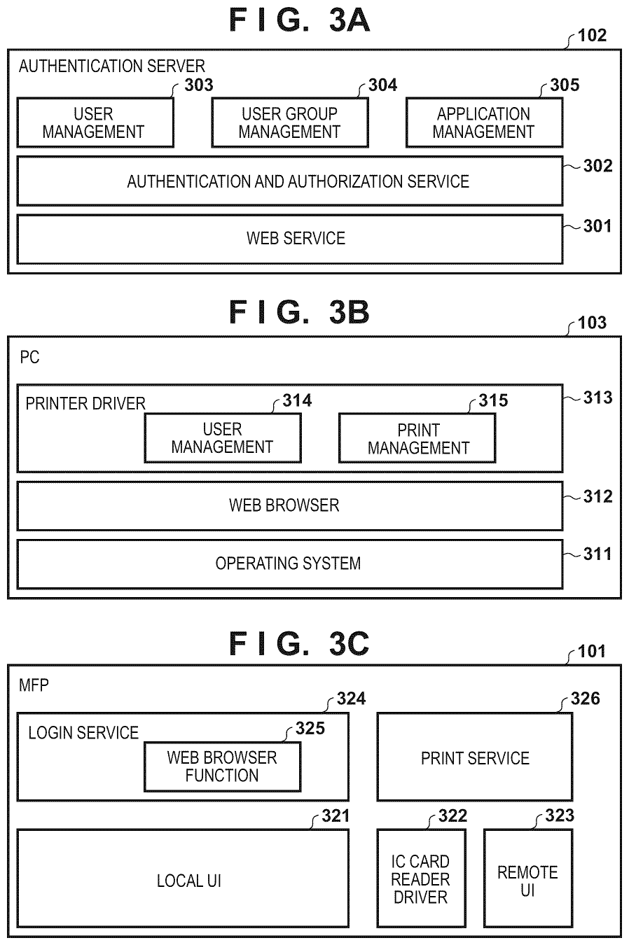

The software configuration of the authentication server 102 will be described next with reference to FIG. 3A. Some of the constituent elements illustrated in FIG. 3A may be omitted from the authentication server 102, or the authentication server 102 may include constituent elements not illustrated in FIG. 3A.

The authentication server 102 centrally manages user accounts (authentication information, user information, and the like) for contracted tenants (organizations such as companies and schools). The authentication server 102 has a function for authenticating users. The authentication server 102 is a server that provides an authentication service such as Microsoft's Microsoft Entra ID (formerly Azure Active Directory), Google Workspace (registered trademark), Okta, or the like, for example. The authentication server 102 may also be referred to as an “identity provider” (IdP). The authentication server 102 identifies a tenant by a tenant ID, a tenant name, or the like. The tenant name may also be referred to as a “domain name” or a “directory name”. For example, the tenant IDs and tenant names in Table 1 are used in Microsoft Entra ID.

TABLE 1

| Item | Value |
|---|---|
| Tenant ID | 14fb6cd1-f816-419a-844a- |
| | 7ad68510ce7c |
| Tenant Name (Domain | tenant.example.com |
| Name) | |

The authentication server 102 has a function of a web service 301 for communicating with clients using Hypertext Transfer Protocol (HTTP). The web service 301 supports OAuth 2.0, OpenID Connect, WS-Federation, SAML 2.0, a Representational State Transfer (REST) API, or the like as an authentication protocol, for example. A REST API provided by Microsoft Entra ID may be referred to as a Graph API.

The web service 301 also provides a web page written in HyperText Markup Language (HTML). The user of the PC 103 can access this web page using a web browser 312 of the PC 103. For example, the administrator of a tenant can use the web page provided by the web service 301 to register and manage accounts of users belonging to that administrator's tenant.

User management 303 is a software module that manages account information of a plurality of users registered using a web page. For example, in Microsoft Entra ID, the information in Table 2 below can be registered as information associated with a single account.

TABLE 2

| | Attribute |
|---|---|
| Item | Name |
| User Principal Name | userPrincipalName |
| Display Name | displayName |
| First Name | GivenName |
| Last Name | surName |
| User Type | userType |
| Job Title | jobTitle |
| Department | department |
| Employee ID | employeeId |
| Usage Location | UsageLocation |
| Address | StreetAddress |
| State/Prefecture | State |
| Country/Region | Country |
| Company | PhysicalDeliveryOfficeName |
| City | City |
| Postal Code | PostalCode |
| Company Phone | telephoneNumber |
| Mobile Phone | mobilePhone |

User principal name is an identifier for uniquely identifying the user. For example, in Microsoft Entra ID, a character string combining the name and the tenant name with “@” is used, such as “alice@tenant.example.com”. Users registered in the user management 303 by the administrator of the tenant can access the web page and use the REST API after authenticating themselves using the registered user principal name and a password.

Information about the user, and particularly information about the characteristics or properties of the user, is called “user attributes”. The user attributes may be represented by a set including a name and a value. The name of the user attribute may be referred to as an “attribute name” or a “user attribute name”. The value of the user attribute may be referred to as an “attribute value” or a “user attribute value”. “Attribute name” in Table 2 is the name of the user attribute. The attribute name represents the type of the attribute value.

The administrator of the tenant can use the web page to create and manage a user group. User group management 304 is a software module that manages the information of registered user groups. The administrator of the tenant can use the web page to register and manage information of applications. “Application” refers to a client that accesses the authentication server 102. The application may be a cloud service provided by another server, an application installed in a mobile terminal, or a service or application operated by the MFP 101. Application management 305 manages application information registered using a web page. Table 3 is an example of the application information.

TABLE 3

| Item | Value |
|---|---|
| Application Name | MFP Login System |
| Application ID (Client ID) | 663a11fc-dp88-4044-a0a7- |
| | bda34091f5d7 |
| Secret | *********** |
| REST API Access | User.ReadAll |
| Permissions | User.ReadWriteAll |
| | Group.ReadAll |

“Application ID” is an identifier for uniquely identifying the application. “Secret” is a password used to authenticate the client as being legitimate. The client id and client_secret defined in “2.3.1. Client Password” of RFC 6749, “The OAuth 2.0 Authorization Framework”, may be used as the application ID and the secret.

The REST API that can be used from an application that has been authenticated successfully may be registered as having access authority for the application. For example, User.ReadAll indicates that all user information can be read out. User. ReadWriteAll indicates that all user information can be read out and written to. Group.ReadAll indicates that all user group information can be read out.

An authentication and authorization service 302 authenticates users and clients accessing the web service 301 by referring to data registered in user management 303, user group management 304, and application management 305. When authentication is successful, the authentication and authorization service 302 grants access permissions to the user and the client.

### Software Configuration of PC 103

The software configuration of the PC 103 will be described next with reference to FIG. 3B. Some of the constituent elements illustrated in FIG. 3B may be omitted from the PC 103, or the PC 103 may include constituent elements not illustrated in FIG. 3B.

The PC 103 has an OS 311, the web browser 312, and a printer driver 313. The present embodiment will describe a case where the OS 311 is Windows. The present embodiment can also be applied when using other OSes, however. The web browser 312 accesses web pages provided by the web service 301 of the authentication server 102.

The printer driver 313 includes user management 314 and print management 315. User management 314 is a software module that manages user information. Print management 315 is a software module that manages print jobs. The printer driver 313 may be a driver additionally installed in the OS 311, or may be a driver provided in the OS 311 as standard.

### Software Configuration of MFP 101

The software configuration of the MFP 101 will be described next with reference to FIG. 3C. Some of the constituent elements illustrated in FIG. 3C may be omitted from the MFP 101, or the MFP 101 may include constituent elements not illustrated in FIG. 3C.

A local user interface (UI) 321 provides a user interface displayed in the operation panel 205. The local UI 321 includes a menu for the user to select functions, a UI platform that controls applications and screen transitions, and the like. For example, the MFP 101 includes a copy application that controls the printer 206 and the scanner 207 to provide a copying function to a user, an application that provides a function for sending a scanned document by controlling the scanner 207 and the communication unit 208, and the like.

A remote UI 323 has an HTTP server function. The remote UI 323 provides the user with a web page written in HTML as a user interface. The user (e.g., an administrator) of the MFP 101 can access the remote UI 323 using the web browser 312 of the PC 103 and change the settings of the MFP 101, use functions of the MFP 101, and the like.

A login service 324 is a software module that authenticates a user using the local UI 321, the remote UI 323, or the like. The login service 324 has a web browser function 325. The web browser function 325 can render a web page written in HTML and display the web page in the operation panel 205 as part of a login screen. The web browser function 325 may be WebKIT or the like. The function by which the application itself displays the web page may also be referred to as “Web View”.

An IC card reader driver 322 is a driver that controls an IC card reader 209. The IC card reader driver 322 obtains information from an IC card and provides this information to the login service 324. A print service 326 receives a print job sent from the PC 103 and prints in accordance with the print job.

### Login Service

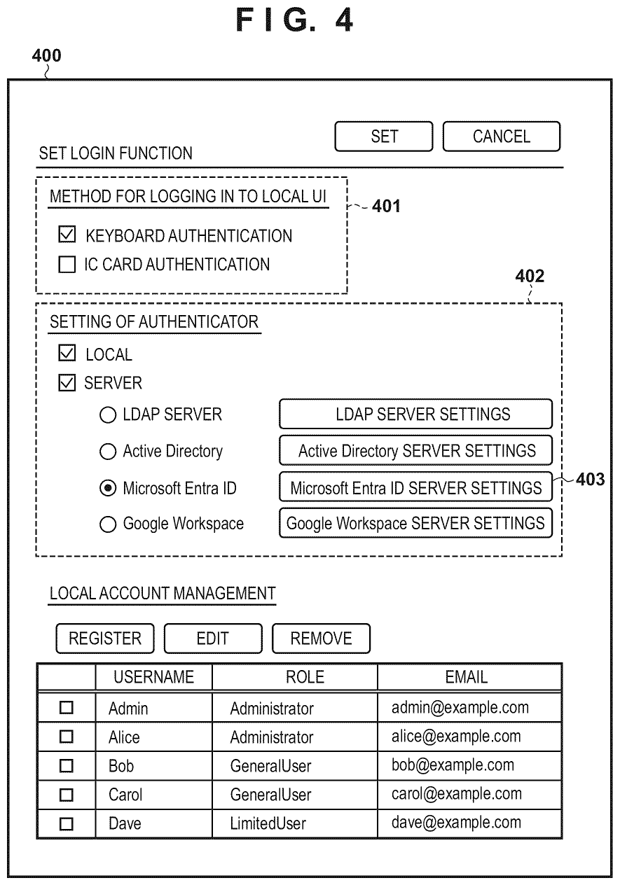

Settings pertaining to a login function of the MFP 101 and functions provided by the login service 324 will be described with reference to FIGS. 4 to 6.

FIG. 4 is an example of a settings page 400 for making settings pertaining to the login function provided by the login service 324. The settings page 400 is a web page provided by the remote UI 323. The settings page 400 is displayed in a display apparatus of a computer that remotely accesses the MFP 101. Values set using the settings page 400 are stored in the HDD 204 of the MFP 101. The login service 324 reads out the settings pertaining to the login function from the HDD 204, and determines the behavior of the login service 324 according to the set values.

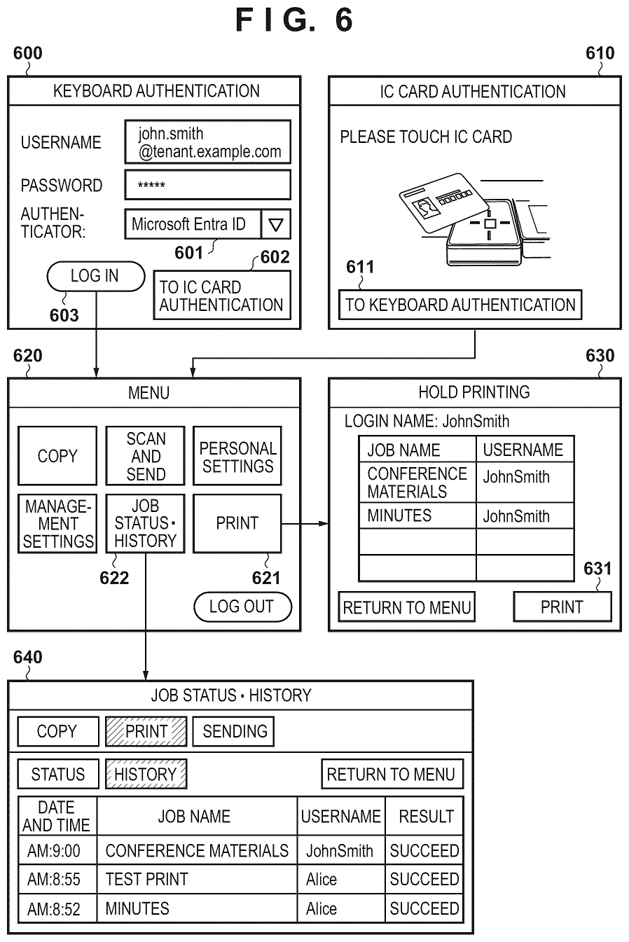

An object for setting a method for logging in to the local UI 321 is disposed in a region 401. In the following descriptions of the screens, “object” refers to a graphic object. In the region 401, “keyboard authentication” and “IC card authentication” can be selected as the login method. Keyboard authentication is a login method for authenticating a user through a username and a password. IC card authentication is a login method for authenticating the user using an IC card in the user's possession. When keyboard authentication is enabled, the login service 324 displays a keyboard authentication screen 600, illustrated in FIG. 6, in the operation panel 205. When IC card authentication is enabled, the login service 324 displays an IC card authentication screen 610, illustrated in FIG. 6, in the operation panel 205. When both keyboard authentication and IC card authentication are enabled, the authentication screen display can be switched between the keyboard authentication screen 600 and the IC card authentication screen 610. For example, the keyboard authentication screen 600 includes a button 602 for transitioning to the IC card authentication screen 610. The IC card authentication screen 610 includes a button 611 for transitioning to the keyboard authentication screen 600.

An object for setting the entity executing the authentication (an authenticator) is disposed in a region 402. In the region 402, “local” and “server” can be selected as the entity executing the authentication. When “local” is selected, authentication is performed using a user account stored in the HDD 204. For example, the login service 324 stores and manages user accounts in a user account table such as that in Table 4. The user account table is a database stored in the HDD 204. The user account table includes a username, a password, a card ID used for IC card authentication, a role, an email address, and the like.

TABLE 4

| | | Card | | |
|---|---|---|---|---|
| Username | Password | ID | Role | Email |
| Admin | ******** | F1EABB15 . . . | Administrator | admin@example.com |
| Alice | ******** | 44E7158E . . . | Administrator | alice@example.com |
| Bob | ******** | 045BB438 . . . | General User | bob@example.com |
| Carol | ******** | 19E313B6 . . . | General User | carol@example.com |
| Dave | ******** | BDFDB35 . . . | Limited User | dave@example.com |

The “role” is information indicating the user's authority to use the MFP 101. An example of each role and usage authority is indicated in Table 5 below. In addition to defining the roles that the MFP 101 has upon being shipped from the factory, the user may be able to set detailed usage authorities and create new roles.

TABLE 5

| Role | Authority |
|---|---|
| Administrator | Settings adjustable, color printing OK, single-sided printing |
| | OK, 1-in-1 printing OK |
| General User | Settings not adjustable, color printing OK, single-sided |
| | printing OK, 1-in-1 printing OK |
| Limited User | Settings not adjustable, color printing prohibited, double-sided |
| | printing OK, 2-in-1 printing OK |

When “server” is selected in the region 402, authentication is performed by the authentication server 102. In the region 402, the type of the server to perform the authentication can also be selected. In the example in FIG. 4, the server can be selected from “LDAP server”, “Active Directory”, “Google Workspace”, and “Microsoft Entra ID”. Furthermore, detailed information of the server can be set by pressing a settings button for each server.

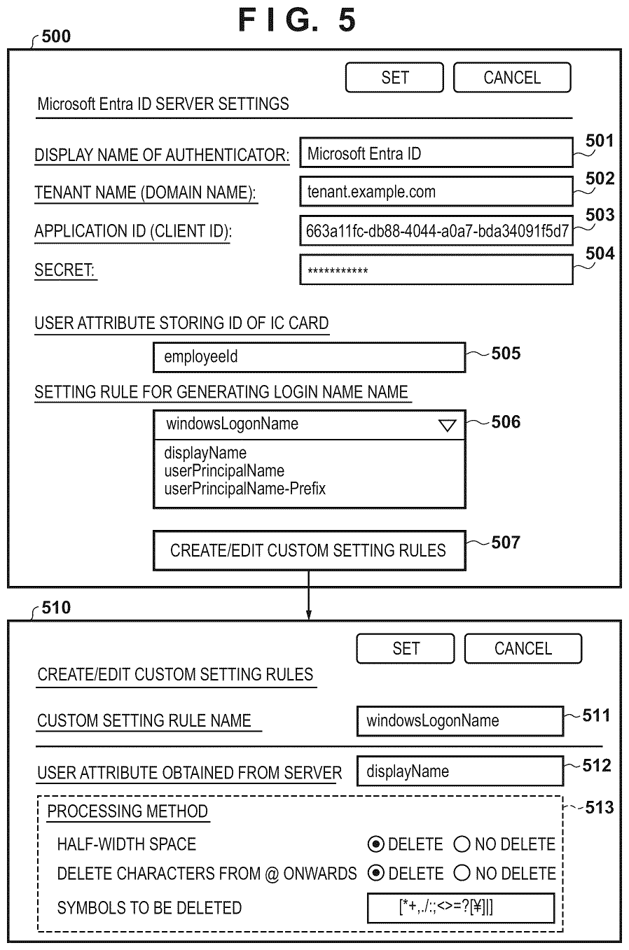

For example, a settings page 500, illustrated in FIG. 5, is displayed when a button 403 for Microsoft Entra ID settings is pressed. The settings page 500 is a web page for setting information used to link with Microsoft Entra ID. An input field 501 (“display name of authenticator”) is an object for obtaining the designation of a character string from the user in order to identify the authenticating entity. The character string designated by the user is displayed in the “authenticator” of the keyboard authentication screen 600. An input field 502 (“tenant name”) is an object for obtaining the designation of a tenant name from the user. For example, the same value as “tenant name” in Table 1 is set in the input field 502. An input field 503 (“application ID”) is an object for obtaining the designation of an application ID from the user. For example, the same value “application ID” in Table 3 is set in the input field 503. An input field 504 (“secret”) is an object for obtaining the designation of a secret from the user. For example, the same value as “secret” in Table 3 is set in the input field 504.

An input field 505 is an object for obtaining the designation of a Microsoft Entra ID user attribute storing the ID of the IC card from the user. “Attribute name” in Table 2 is used to specify the Microsoft Entra ID user attribute. For example, if an employee ID stored in the IC card is used for authentication, “employeeId” is set in the input field 505. In addition, “employeeId” may be used as a region for storing an ID (a serial number) of the IC card.

A pull-down list 506 is an object for obtaining the designation of a user attribute used for the logged-in username after logging in from the user. In the example illustrated in FIG. 5, the pull-down list 506 is a pull-down list containing four candidates. An input field in which a user can freely input a character string may be used instead of the pull-down list 506. The options in the pull-down list 506 include “WindowsLogonName”, “displayName”, “userPrincipalName”, and “userPrincipalName-Prefix”.

Each of the plurality of options in the pull-down list 506 represents a setting rule for setting the logged-in username of the user of the MFP 101. Each setting rule includes the type of user attribute value used to set the logged-in username and a setting regarding whether to process the user attribute value. If processing the user attribute value is set, the setting rule further includes a method for processing the user attribute value. The user attribute value used to set the logged-in username is obtained from the authentication server 102.

The relationship between the setting rules that can be selected in the pull-down list 506, the type of the user attribute used, and the method for processing the attribute value is indicated in the following Table 6.

TABLE 6

| Selectable | User | |
|---|---|---|
| Setting | Attributes | Attribute Value |
| Rules | Used | Processing Method |
| WindowsLogonName | displayName | Delete half-width spaces |
| | | Delete symbols *+,./:;<>=? [¥]\| |
| | | Delete characters from “@” onwards |
| | | Delete characters exceeding 20 characters |
| | | to keep character string within 20 characters |
| displayName | displayName | Do not process |
| userPrincipalName | userPrincipalName | Do not process |
| userPrincipalName-Prefix | userPrincipalName | Extract character strings to the left of |
| | | “@” |

Of the options in the pull-down list 506, “displayName” and “userPrincipalName” are setting rules that set the user attribute value stored in the authentication server 102 (e.g., Microsoft Entra ID) as-is as the logged-in username. Meanwhile, of the options in the pull-down list 506, “WindowsLogonName” and “userPrincipalName-Prefix” are setting rules that set values obtained by processing the user attribute value stored in the authentication server 102 (e.g., Microsoft Entra ID) as the logged-in username. A setting rule in which the user attribute value is processed in this manner is referred to as a custom setting rule.

“WindowsLogonName” and “userPrincipalName-Prefix” are built-in setting rules implemented in the MFP 101 in advance. In the example in Table 7, when the custom setting rule “WindowsLogonName” is selected, the MFP 101 obtains the value of the user attribute “displayName” from Microsoft Entra ID, and uses a value obtained by processing that value according to the processing method in Table 7 as the logged-in username. The processing method may include at least one of removing a specific type of character from the user attribute value, extracting a part before a specific type of character from the user attribute value, and removing a part exceeding a threshold number of characters from the user attribute value.

For example, it is assumed that the user attributes in Table 7 below are set for a single user account in Microsoft Entra ID.

TABLE 7

| Attribute | |
|---|---|
| Name | Value |
| userPrincipalName | john.smith@tenant.example.com |
| displayName | John Smith |

The logged-in usernames used in the MFP 101 when the respective options in the pull-down list 506 have been selected are indicated in Table 8 below.

TABLE 8

| Selected | Logged-In |
|---|---|
| Setting | Username |
| Rules | Set |
| userPrincipalName | john.smith@tenant.example.com |
| displayName | John Smith |
| windowsLogonName | JohnSmith |
| userPrincipalName-Prefix | john.smith |

When “userPrincipalName” is selected, the value of the user attribute “userPrincipalName” in Microsoft Entra ID is used as-is. When “displayName” is selected, the value of the user attribute “displayName” in Microsoft Entra ID is used as-is. When “windowsLogonName” is selected, a value obtained by removing half-width spaces from the value of the user attribute “displayName” in Microsoft Entra ID is used. When “userPrincipalName-Prefix” is selected, the part before the “@” in the value of the user attribute “userPrincipalName” in Microsoft Entra ID is used.

The user of the MFP 101 may be able to edit existing custom setting rules, or may be able to create new custom setting rules. For example, the MFP 101 displays an editing screen 510 in the operation panel 205 in response to a button 507 in the settings page 500 being pressed.

An input field 511 is an object for obtaining the designation of a name of the custom setting rule from the user. The user (e.g., an administrator of the MFP 101) can specify any character string that is not the same as the existing user attributes when creating a new custom setting rule. An input field 512 is an object for obtaining the designation of a name of a user attribute obtained from the authentication server 102 (e.g., Microsoft Entra ID) from a user. An object for obtaining the designation of the method of processing the attribute value obtained from the authentication server 102 from the user is disposed in a region 513. In the example of FIG. 5, the user can specify whether to delete half-width spaces, whether to delete the character string from the “@” onwards, and the types of symbols to be deleted. The configuration is not limited to the example in FIG. 5, however, and the MFP 101 may be capable of obtaining the designation of a processing method using a regular expression or the like, for example. The MFP 101 creates a new setting rule based on inputs made in the editing screen 510 by the user, and adds the new setting rule to the existing setting rules. The selection rule is displayed as an option in the pull-down list 506 as a result.

### Print Service

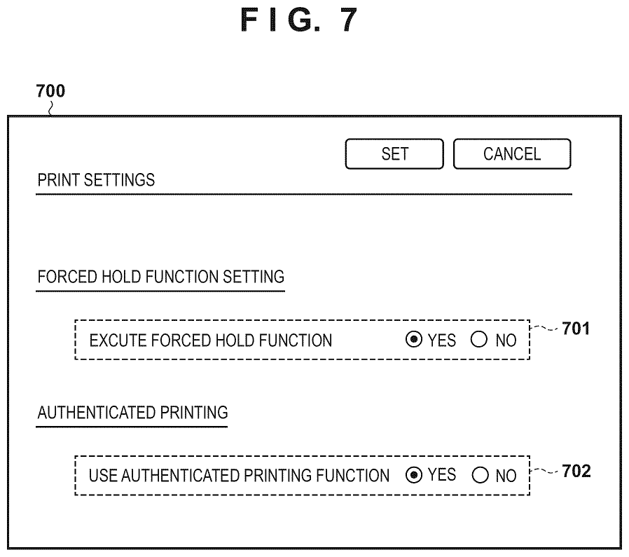

Settings pertaining to a print function of the MFP 101 and functions provided by the print service 326 will be described with reference to FIG. 7. The print service 326 controls print jobs sent from a printer driver 313.

FIG. 7 illustrates an example of a settings page 700 for making settings pertaining to the print function provided by the print service 326. The settings page 700 is a web page provided by the remote UI 323. The settings page 700 is displayed in a display apparatus of a computer that remotely accesses the MFP 101. Values set using the settings page 700 are stored in the HDD 204 of the MFP 101. The print service 326 reads out the settings pertaining to the print function from the HDD 204, and determines the behavior of the print service 326 according to the set values.

The print service 326 has a function for temporarily storing and holding print jobs sent from the printer driver 313 in the HDD 204 or the RAM 203. This function is called a “forced hold” function. An object 701 obtains a designation of whether to enable or disable the forced hold function from the user. The print job may be held in an external apparatus, such as a print server, instead of being held in the MFP 101.

When the forced hold function is enabled, the MFP 101 stores the print job received from the PC 103 in the HDD 204, the RAM 203, or the like instead of immediately executing the print job. In response to the user logging in to the MFP 101 and instructing a list of print jobs to be displayed, the MFP 101 displays a list of print jobs having a job owner name that matches the logged-in username of the user logged in to the MFP 101, as indicated by a screen 630 in FIG. 6. Then, in response to a displayed print job being selected and a “print” button being pressed, the MFP 101 prints according to the selected print job. When the forced hold function is disabled, the MFP 101 prints immediately according to the obtained print job.

An object 702 obtains an instruction as to whether to enable or disable an authenticated printing function from the user. When the authenticated printing function is enabled, the MFP 101 rejects the printing of print jobs which do not include authentication information, a print ticket, or the like. When the authenticated printing function is disabled, the MFP 101 prints regardless of whether the print job includes authentication information, a print ticket, or the like.

### Operations by Printer Driver

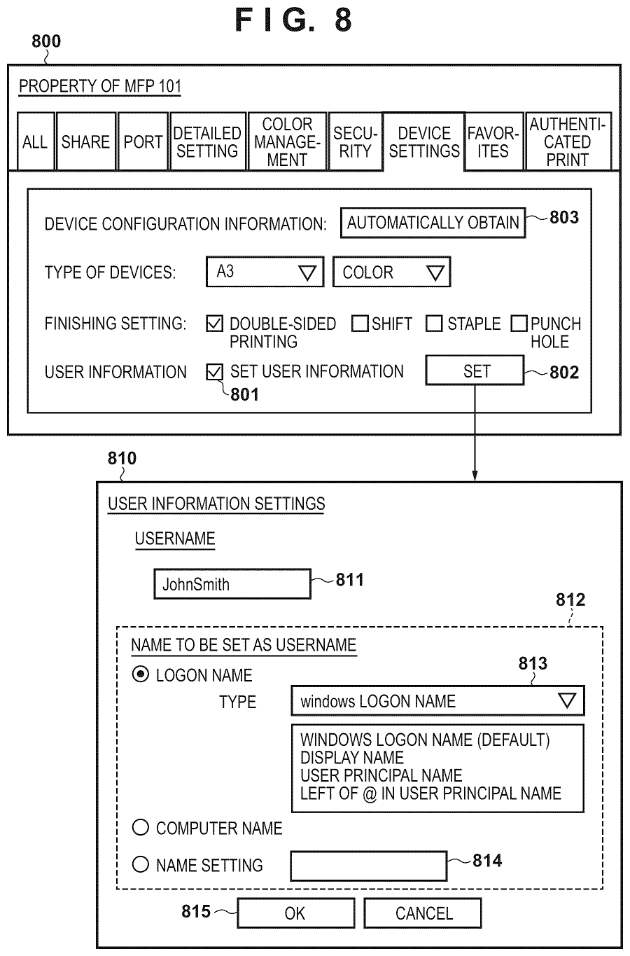

Operations performed by the printer driver 313 of the PC 103 will be described with reference to FIGS. 8 to 10. FIG. 8 is an example of a properties screen 800 for making settings pertaining to the print function provided by the printer driver 313. The properties screen 800 is displayed in the display apparatus of the PC 103. Values set using the properties screen 800 are stored in the HDD 214 of the PC 103. The printer driver 313 reads out the settings pertaining to the print function from the HDD 214, and determines the behavior of the printer driver 313 in accordance with the set values. The user of the PC 103 may be required to log on to the PC 103 in order to display the properties screen 800. The user may log on to the PC 103 using a user account stored in the PC 103, or using the authentication server 102.

The user management 314 displays a settings screen 810 for setting user information in response to a button 802 being pressed on the properties screen 800. A display field 811 indicates a username which is currently set. An object for obtaining the designation of a setting rule for setting the username from the user is disposed in a region 812. The user can select one of three setting rules, namely “logon name”, “computer name”, and “name setting”.

When “logon name” is selected, the user can select a setting rule for setting the username from a plurality of setting rules. In the example in FIG. 8, a pull-down list 813 enables a setting rule to be selected from among four setting rules. When “computer name” is selected, the computer name of the PC 103 is designated as the username. When “name setting” is selected, a character string input to an input field 814 by the user is designated as the username.

Each of the plurality of setting rules that can be selected using the pull-down list 813 includes the type of user attribute value that can be used to set the username, and a setting as to whether to process the user attribute value. If processing the user attribute value is set, the setting rule further includes a method for processing the user attribute value. The user attribute value used to set the username is obtained from the OS 311. As with the setting rules for the MFP 101 described above, setting rules in which the user attribute value is processed will be referred to as “custom setting rules” in the PC 103 as well.

The relationship between the setting rules that can be selected in the pull-down list 813, the type of the user attribute used, and the method for processing the attribute value is indicated in the following Table 9. The content in Table 9 is similar to that in Table 6, and redundant descriptions will therefore be omitted.

TABLE 9

| Selectable | User | |
|---|---|---|
| Setting | Attributes | Attribute Value |
| Rules | Used | Processing Method |
| Windows Logon Name | Windows Logon Name | Do not process |
| Display Name | Display Name | Do not process |
| User Principal Name | User Principal Name | Do not process |
| Left of “@” in User | User Principal Name | Extract character strings |
| Principal Name | | to the left of “@” |

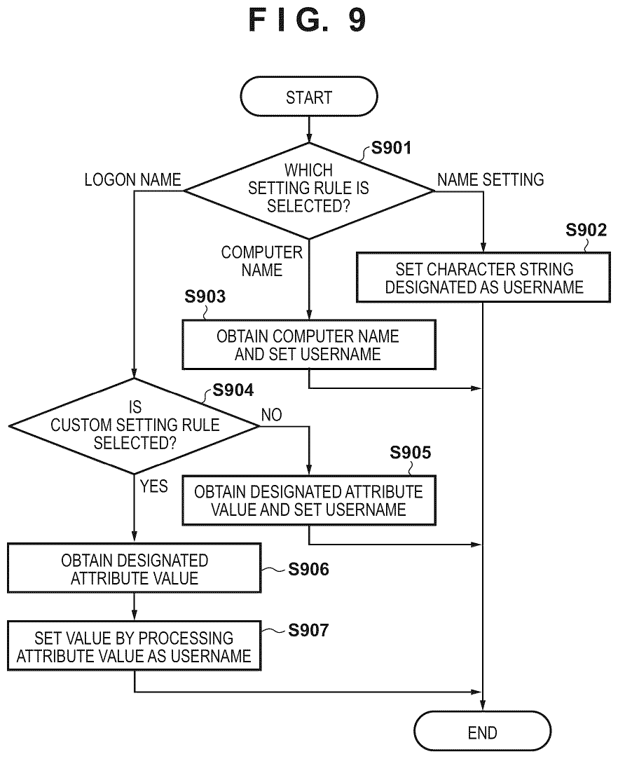

FIG. 9 illustrates operations performed by the printer driver 313, executed in response to a button 815 being pressed after a setting rule for setting the username has been designated in the region 812 of the settings screen 810. According to the method in FIG. 9, the printer driver 313 sets the username in accordance with a designation made by the user. The method in FIG. 9 is defined by the printer driver 313, a software program of the OS 311, or the like. The software program is stored in non-volatile storage of the PC 103, such as the ROM 212, the HDD 214, or the like, loaded into the RAM 213, and executed by the CPU 211. The printer driver 313, the OS 311, and the like are also provided with Application Programming Interfaces (APIs), and can cooperate by using the APIs. API calls will be omitted from the descriptions of FIG. 9.

In step S901, user management 314 specifies the setting rule designated in the region 812. User management 314 moves the sequence to step S904 when “logon name” is designated; to step S903, when “computer name” is designated; and to step S902 when “name setting” is designated.

In step S902, user management 314 sets the character string input in the input field 814 as the username, and displays the username in the display field 811. In step S903, user management 314 obtains the computer name of the PC 103, sets the computer name as the username, and displays the username in the display field 811.

In step S904, user management 314 determines whether a custom setting rule is selected in the pull-down list 813 as the setting rule for the logon name. User management 314 moves the sequence to step S906 if the custom setting rule is determined to be selected (“YES” in step S904), and to step S905 if not (“NO” in step S904).

The options in the pull-down list 813 include setting rules for setting a user attribute value as-is as the username, as well as setting rules for setting a value obtained by processing a user attribute value as the username (i.e., custom setting rules). In the example in FIG. 8, “left of the ‘@’ in the user principal name” is a custom setting rule, whereas the other options are not custom setting rules.

In step S905, user management 314 obtains the attribute value of the logged-in user (“Windows logon name”, “display name”, or “user principal name”) from the OS 311 using the API of the OS 311, in accordance with the method for obtaining the logon name selected in the pull-down list 813.

The OS 311 sets the logon name based on the user attribute value obtained from the authentication server 102 when the user logs in to the OS 311 using the user account of the authentication server 102. For example, a case where the authentication server 102 uses Microsoft Entra ID and the OS 311 is Windows will be described next. In this case, the user attribute “userPrincipalName” is used to log in to the OS 311. The user attribute is a unique identifier on the Internet and is formed, for example, in a format similar to an email address, such as username@tenant.example.com. After the user logs in to the OS 311, the OS 311 uses the Windows logon name to identify the user. The OS 311 obtains the value of the user attribute “displayName” from the authentication server 102, and sets a value obtained by processing this value as the Windows logon name. What kind of processing is performed depends on the type of the OS, and for example, in Windows, “half-width spaces”, “some symbols”, and “character string from the ‘@’ onwards” are deleted.

When “Windows logon name” is selected, user management 314 obtains the Windows logon name generated as described above from the OS 311, and sets that value as the username. The “Windows logon name” can be obtained using the GetUserName function provided by Windows. When “display name” is selected, user management 314 obtains the display name from the OS 311, and sets that value as the username. The “display name” can be obtained using the GetUserNameEx function provided by Windows. When “user principal name” is selected, user management 314 obtains the user principal from the OS 311, and sets that value as-is as the username. User management 314 sets the obtained attribute value as the username, and displays the username in the display field 811. Whether the PC 103 is linked to Microsoft Entra ID can be confirmed using the NetGetAadJoinInformation function provided by Windows. If Windows is not set to be linked with Microsoft Entra ID, the printer driver 313 may disable the selection of “display name”, “user principal name”, or “left of the ‘@’ in the user principal name” in the pull-down list 813.

In step S906, user management 314 obtains the attribute value of the logged-in user (“user principal name”) from the OS 311 using the API of the OS 311, in accordance with the method for obtaining the logon name selected in the pull-down list 813. In step S907, user management 314 stores a value obtained by processing the obtained attribute value according to a processing method as the username, and displays the username in the display field 811. For example, “left of the ‘@’ of the user principal name” defines processing for extracting the part before the “@” of the user principal name.

Through the foregoing method, the username is set according to the setting rules specified by the user, and is stored for subsequent processing.

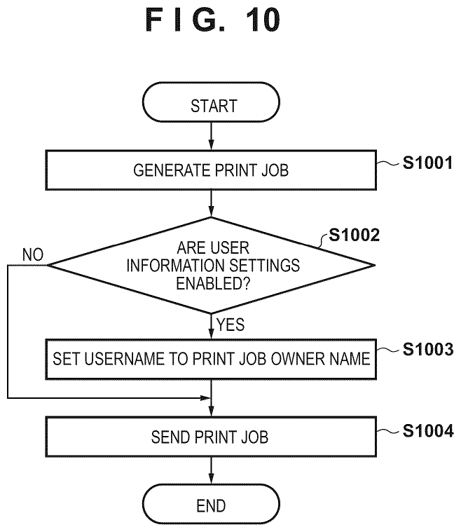

FIG. 10 illustrates operations performed by the printer driver 313 in response to obtaining an instruction to print from the user of the PC 103 (referred to hereinafter simply as the “user” in the method illustrated in FIG. 10). In step S1001, print management 315 generates a print job in accordance with the instruction from the user. The print job can include print data in a printing format and settings for printing the print data.

In step S1002, print management 315 determines whether user information settings are enabled. Print management 315 determines that the user information settings are enabled when a checkbox 801 in the properties screen 800 is checked. Print management 315 moves the sequence to step S1003 if the user information settings are determined to be enabled (“YES” in step $1002), and to step S1004 if not (“NO” in step S1002).

In step S1003, print management 315 assigns the username set through the method illustrated in FIG. 9 to the print job generated in step S1001. For example, print management 315 sets the username set through the method illustrated in FIG. 9 as the owner name of the print job generated in step S1001. A print job having the username set through the method illustrated in FIG. 9 is generated as a result. If step S1003 is not executed, setting the owner name of the print job may be skipped, or the “Windows logon name” may be set. In step S1004, print management 315 sends the generated print job to the MFP 101. Instead, however, print management 315 may send the print job to a print server, and the MFP 101 may obtain the print job from the print server.

### Operations in Login Service

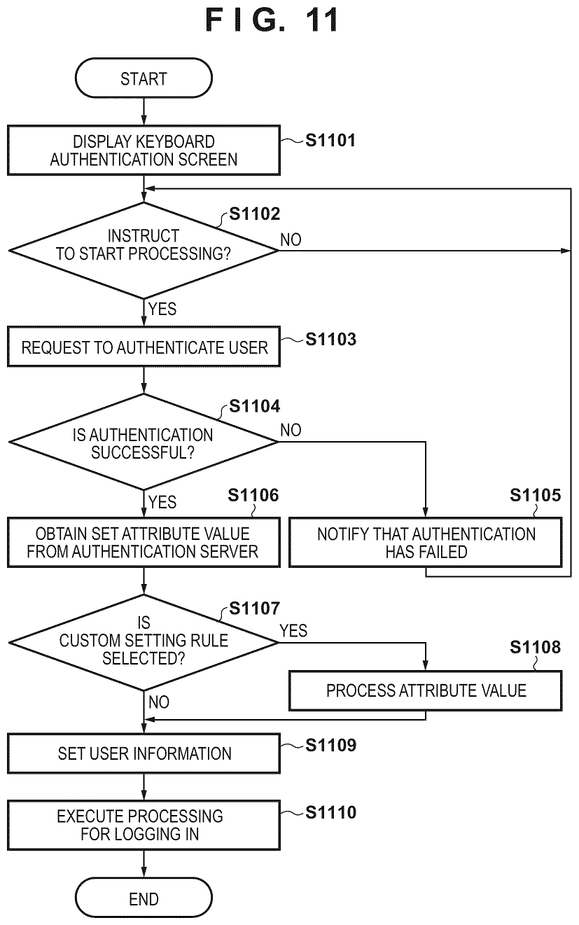

Operations performed by the MFP 101 with respect to the login service 324 will be described with reference to FIG. 11. The method in FIG. 11 is defined by software programs of the local UI 321, the remote UI 323, the login service 324, and the IC card reader driver 322. The software program is stored in non-volatile storage of the MFP 101, such as the ROM 202, the HDD 214, or the like, loaded into the RAM 203, and executed by the CPU 201. Software, such as the local UI 321, the remote UI 323, the login service 324, the IC card reader driver 322, and the like, also provide APIs to each other and cooperate by using the APIs. API calls will be omitted from the descriptions of FIG. 11. The method illustrated in FIG. 11 may be started in response to the MFP 101 being turned on, or in response to the user instructing the keyboard authentication screen 600 illustrated in FIG. 6 to be displayed. In the method illustrated in FIG. 11, a user logs in to the MFP 101 using an account of the authentication server 102 (e.g., Microsoft Entra ID).

In step S1101, the login service 324 displays the keyboard authentication screen 600 in the operation panel 205. In step S1102, the login service 324 determines whether an instruction to start login processing has been obtained from the user of the MFP 101 (hereinafter simply referred to as the “user” in the descriptions of FIG. 11). The login service 324 moves the sequence to step S1103 if an instruction to start the login processing is determined to have been obtained (“YES” in step S1102), and repeats step S1102 if not (“NO” in step S1102). The login service 324 may determine that an instruction to start the login processing has been obtained based on a button 603 in the keyboard authentication screen 600 being pressed. The following descriptions assume that the Microsoft Entra ID is selected as the “authenticator” in a pull-down list 601 of the keyboard authentication screen 600. The same descriptions apply when another type of authentication server 102 is selected as the “authenticator”.

In step S1103, the login service 324 requests the authentication server 102 (Microsoft Entra ID) to authenticate the user based on the information input by the user in the keyboard authentication screen 600. Specifically, the login service 324 sends an authentication request, including the username and password input in the keyboard authentication screen 600, to the authentication server 102. The value of the user attribute “userPrincipalName” is input as the username, for example.

The authentication request may be performed using the Access Token Request described in “4.3. Resource Owner Password Credentials Grant” of RFC 6749, “The OAuth 2.0 Authorization Framework”. For example, the information in the following Table 10 may be sent through the POST method of HTTP to a predetermined URL of the authentication server 102.

TABLE 10

| Item | Value |
|---|---|
| grant_type | password |
| username | john.smith@tenant.example.com |
| password | ******** |
| scope | default |
| client_id | 663a11fc-db88-4044-a0a7- |
| | bda34091f5d7 |

“scope” indicates the range of resources that can be accessed using an access token generated when authentication succeeds. The login service 324 specifies a scope necessary for obtaining a user profile (user attributes), such as an email address, through the REST API.

In step S1104, the login service 324 determines whether the authentication is successful based on a response from the authentication server 102. The login service 324 moves the sequence to step S1106 if the authentication is determined to be successful (“YES” in step S1104), and to step S1105 if not (“NO” in step S1104). For example, the login service 324 determines that the authentication is successful when an access token is received from the authentication server 102 in response to the request sent in step S1103. The login service 324 determines that the authentication has failed when an error indicating that username or password verification has failed is received from the authentication server 102 in response to the request sent in step S1103.

If the authentication is determined to have failed, in step S1105, the login service 324 notifies the user that the authentication has failed. For example, the login service 324 displays, in the operation panel 205, an error indicating that the username or password input in the keyboard authentication screen 600 is invalid.

The processing from step S1106 onward is executed when the user authentication by the authentication server 102 is determined to have succeeded. In step S1106, the login service 324 determines the type of the user attribute value obtained from the authentication server 102, and obtains the user attribute value of that type from the authentication server 102. Specifically, the login service 324 determines the type of the user attribute value obtained from the authentication server 102 based on the setting rule designated in the pull-down list 506 of the settings page 500. The type of the user attribute value obtained from the authentication server 102 for the individual setting rules designated in the pull-down list 506 are as described earlier with reference to Table 6.

The login service 324 makes a request to the authentication server 102 for the user attribute value of the type determined in this manner. Specifically, the login service 324 accesses the REST API of the authentication server 102 using the access token obtained in step S1104, and makes the request for the user attribute value. The login service 324 may obtain only the user attribute value of a specific type, or may obtain all the user attribute values that can be obtained. For example, it may be possible to obtain the user attribute values indicated in Table 2 above from the authentication server 102. For example, by holding the access token in the HTTP Authorization header and sending a GET request to a predetermined REST API URL, the login service 324 can receive the user attribute values indicated in Table 2 as a response to the request.

In step S1107, the login service 324 determines whether the setting rule designated in the pull-down list 506 of the settings page 500 is a custom setting rule. The login service 324 moves the sequence to step S1108 if the setting rule is determined to be a custom setting rule (“YES” in step S1107), and to step S1109 if not (“NO” in step S1107). In step S1108, the login service 324 processes the user attribute value obtained in step S1106 according to the processing method. The user attribute value processing method is as described above with reference to Table 6.

In step S1109, the login service 324 instantiates a structure that holds the user information of the logged-in user (called “login context” hereinafter). The following Table 11 is an example of the user information included in the login context.

TABLE 11

| Item | Value |
|---|---|
| Logged-In Username | JohnSmith |
| Email Address | john.smith@example.com |
| Role | Administrator |

If step S1108 has been performed, the logged-in username is a value obtained by the processing of step S1108, whereas if step S1108 has not been performed, the logged-in username is the user attribute value obtained in step S1106. Table 11 indicates an example in which the setting rule “windowsLogonName” is designated in the pull-down list 506. In this case, according to Table 6, “John Smith”, which is the value of the user attribute “displayName”, is obtained from the authentication server 102. Then, “JohnSmith”, which is obtained by removing the half-width spaces from “John Smith” in accordance with the processing method, is taken as the logged-in username.

The “role” in the user information may, for example, be determined based on the job title (job Title) in the user attributes obtained from the authentication server 102, or may be determined based on information about a user group to which the user belongs, obtained from the authentication server 102. The MFP 101 may have a function for determining a relationship between user information that can be obtained from the authentication server 102 and the role of the MFP 101.

In step S1110, the login service 324 logs the user in to the MFP 101 by executing processing for logging in to the MFP 101 using the login context generated in step S1109. Specifically, the login service 324 notifies the local UI 321 of the login context via an API. In response to the login context notification, the local UI 321 detects that the user has logged in to the MFP 101, closes the keyboard authentication screen 600 of the operation panel 205, and displays a menu screen 620. The menu screen 620, and screens which can be transitioned to therefrom (e.g., a list screen 630 and a status/history screen 640), are displayed while the user is logged in to the MFP 101.

The local UI 321 displays the list screen 630 in response to the user pressing a button 621 in the menu screen 620. The list screen 630 includes a list of print jobs which have a job owner name matching the logged-in username included in the login context, and which are held in the MFP 101. The local UI 321 identifies print jobs having the logged-in username of the MFP 101 as print jobs of the user logged in to the MFP 101, and includes those print jobs in the print job list.

For example, assume that the logged-in username included in the login context is “JohnSmith”, as in the example described above. When “Windows logon name” is designated in the pull-down list 813 of the printer driver 313 of the PC 103, the owner name of the print job is also “JohnSmith”. As such, using the logged-in username of the user of the MFP 101, the MFP 101 can correctly associate the user who is logged in to the MFP 101 with the user who submitted the print job to the MFP 101. Specifically, print jobs to which the same username as the logged-in username of the user logged in to the MFP 101 has been assigned by the PC 103 are displayed in the list screen 630. Then, in response to a button 631 being pressed while a print job is selected in the list screen 630, the print service 326 of the MFP 101 prints according to that print job.

The local UI 321 displays the status/history screen 640 in response to the user pressing a button 622 in the menu screen 620. The owner name of each print job is displayed as the username of each print job included in the status/history screen 640. On the other hand, the logged-in username of the user logged in to the MFP 101 is displayed as the username of each of copy jobs included in the status/history screen 640. The jobs to be executed by the MFP 101 can be correctly aggregated on a user-by-user basis by matching the owner name of each print job (i.e., the username of the user of the PC 103) with the logged-in username of the user logged in to the MFP 101.

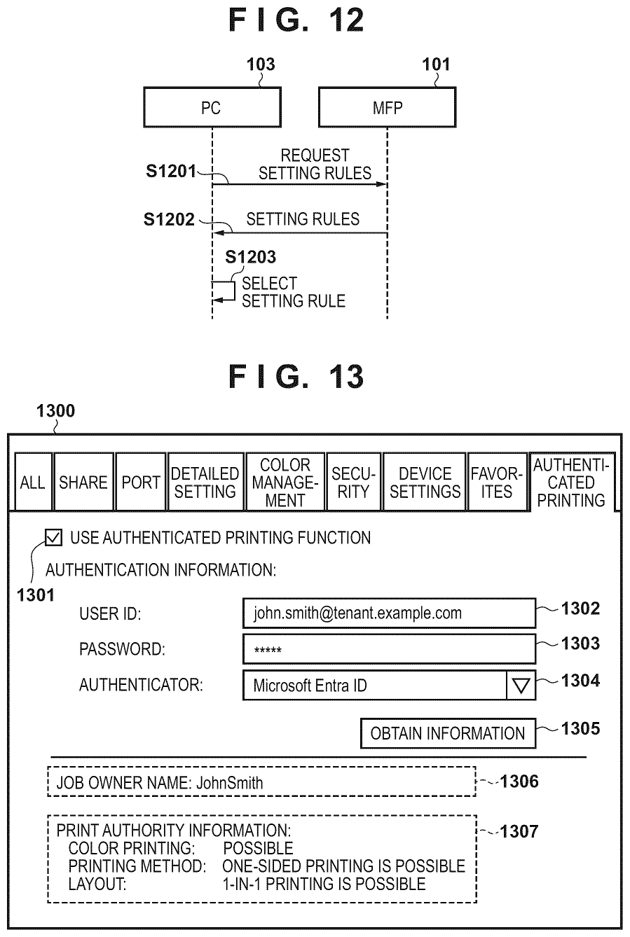

In the method described above, at least one of the setting rules in the MFP 101 and the setting rules in the PC 103 is designated such that the logged-in username of the user logged in to the MFP 101 matches the username of the user of the PC 103. The setting rules of the MFP 101 are designated by the user of the MFP 101 (e.g., an administrator). The setting rules of the PC 103 are designated by the user of the PC 103. However, designating the setting rules may be troublesome, errors may be made when designating the setting rules, and the like. Accordingly, the setting rules of the MFP 101 and the setting rules of the PC 103 may be synchronized through the method illustrated in FIG. 12. The method in FIG. 12 may be started in response to a button 803 in the properties screen 800 being pressed by the user of the PC 103, for example. Instead, however, the method in FIG. 12 may be performed when an installer of the printer driver 313 installs the printer driver 313 for the MFP 101. The installer of the printer driver 313 can change the default values of settings by accessing a configuration file of the printer driver 313 or the registry.

In step S1201, print management 315 of the PC 103 makes a request, to the MFP 101, for the setting rules set in the MFP 101. In step S1202, the MFP 101 sends the setting rules set in the MFP 101 to the PC 103 in response to the request. The communication in steps S1201 and S1202 may be performed using HTTP, SNMP, or the like, i.e., SOAP, REST, or the like, or may be performed using a proprietary protocol of the vendor of the MFP 101. In this manner, print management 315 of the PC 103 obtains the setting rules used by the MFP 101 to set the logged-in username of the user of the MFP 101. All the configuration information of the MFP 101 may be requested in step S1201, and in step S1202, the setting rules may be sent as part of the configuration information of the MFP 101 (e.g., information such as the setting values of the MFP 101, whether optional items are attached, and the like).

As described above, each setting rule includes the type of user attribute value used to set the logged-in username and a setting regarding whether to process the user attribute value. If processing the user attribute value is set, the setting rule further includes a method for processing the user attribute value. If the type of the user attribute value used to set the logged-in username differs according to the type of the authentication server 102, the MFP 101 may further send the type of the authentication server 102 to the PC 103.

In step S1203, print management 315 of the PC 103 selects the setting rule to be used to set the username of the PC 103 from the plurality of setting rules in the PC 103, based on the setting rule obtained from the MFP 101. For example, if Microsoft Entra ID is used for the authentication server 102 and a setting rule stating that the user attribute “userPrincipalName” is to be used as-is is obtained, the PC 103 selects “user principal name” in the pull-down list 813 from the plurality of setting rules that can be selected in the region 812. In this manner, the PC 103 selects the setting rule such that the username set in the PC 103 matches the logged-in username set in the MFP 101. If a notification that server authentication is not to be performed has been made, the type of the user attribute included in the obtained setting rule is unknown, or the like, the PC 103 may select the default “Windows logon name”.

Then, the PC 103 sets the username of the PC 103 by performing the method illustrated in FIG. 9 using the setting rule selected in step S1203. The username set in this manner matches the logged-in username set by the MFP 101.

If the PC 103 is capable of using a plurality of MFPs 101, the method illustrated in FIG. 12 may be performed by each MFP 101. Specifically, the PC 103 may select individual setting rules from the plurality of setting rules that can be selected in the region 812 for each of the plurality of MFPs 101.

In the foregoing embodiment, the information of the MFP 101 is obtained by the PC 103 without going through the print server. Instead, however, the information of the MFP 101 may be obtained by the PC 103 via a print server. For example, the print server may store the information of the MFP 101, and the PC 103 may obtain the information of the MFP 101 stored in the print server. Additionally, in the foregoing embodiment, the print jobs generated by the PC 103 are sent to the MFP 101 without going through the print server. Instead, however, the print jobs generated by the PC 103 may be sent to the MFP 101 via the print server. For example, the PC 103 submits a print job to a logical printer managed by the print server. The MFP 101 may obtain a print job associated with the logical printer associated with the MFP 101 itself.

### Effects of First Embodiment

According to the foregoing embodiment, the logged-in username of the user logged in to the MFP 101 can be caused to match the username of the user logged in to the PC 103 in an environment in which both the MFP 101 and the PC 103 can authenticate the user using the authentication server 102. This increases the convenience for the user. Specifically, when using Microsoft Entra ID for the authentication server 102, the MFP 101 can use the same username as the Windows logon name for the logged-in username of the user logged in to the MFP 101, by obtaining the display Name attribute value from the authentication server 102 and processing that attribute value. Accordingly, even if the owner name of the print job generated by the PC 103 is a Windows logon name, the MFP 101 can associate the print job with the user logged in to the MFP 101.

It is also possible for the MFP 101 to set the logged-in username in accordance with a setting rules generated by the user themselves. Through this, even if the rules for generating the owner name of a print job have been changed due to a change in the usage of the OS 311, the printer driver 313, or the like of the PC 103, changes on the PC 103 side can be handled in a flexible manner by changing the setting rules of the MFP 101.

The “Windows logon name” and “display name” may not be unique on the Internet, and may be the same as the values for other users. However, the “user principal name” is unique on the Internet. According to the foregoing embodiment, the “user principal name” can be set in each of the MFP 101 and the

PC 103, which makes it possible to avoid situations where the usernames are the same. The “user principal name” has more characters than the “Windows logon name” and “display name”, however, and may therefore be difficult for the user to handle. According to the foregoing embodiment, a setting rule for extracting the part “left of the ‘@’ in the user principal name” can also be selected. This makes it possible to set a username that is not too long and easy to handle while also ensuring the uniqueness of the username in operations performed within the same tenant (the same domain).

Furthermore, in the foregoing embodiment, the PC 103 has a function for automatically associating the setting rules of the MFP 101 with the setting rules of the PC 103. This makes it possible to suppress username mismatches between the MFP 101 and the PC 103 caused by erroneous settings in the setting rules.

### Second Embodiment

A second embodiment will be described next. The following will describe differences from the first embodiment. Details not described in the second embodiment may be the same as those in the first embodiment. In the second embodiment, during authenticated printing, the PC 103 assigns a username designated by the MFP 101 to the print job. “Authenticated printing” is a printing method that requires a user to be authenticated in order to submit a print job to the MFP 101 from the PC 103.

An example of a settings screen 1300 for using authenticated printing will be described with reference to FIG. 13. The settings screen 1300 is displayed in the display apparatus of the PC 103 by the printer driver 313. A checkbox 1301 is an object for obtaining, from the user, the designation of whether to use authenticated printing. The printer driver 313 may obtain the settings of the object 702 of the MFP 101 and automatically set the checkbox 1301 based on those settings. An input field 1302 is an object for obtaining a user identifier from the user. For example, the user inputs the user principal name. An input field 1303 is an object for obtaining a password from the user. A pull-down list 1304 is an object for obtaining the designation of the entity executing the authentication (any one authentication server 102) from the user. The printer driver 313 may set the options in the pull-down list 1304 based on the “authenticator” set in the MFP 101 using the region 402 of the settings page 400.

When a specific type of authentication server 102 (e.g., Microsoft Entra ID) is selected in the pull-down list 1304, the printer driver 313 may obtain the user identifier (e.g., the user principal name) used by the authentication server 102 for authentication from the OS 311 and set that user identifier in the input field 1302. The user identifier obtained by the printer driver 313 is the user identifier of the user logged in to the PC 103.

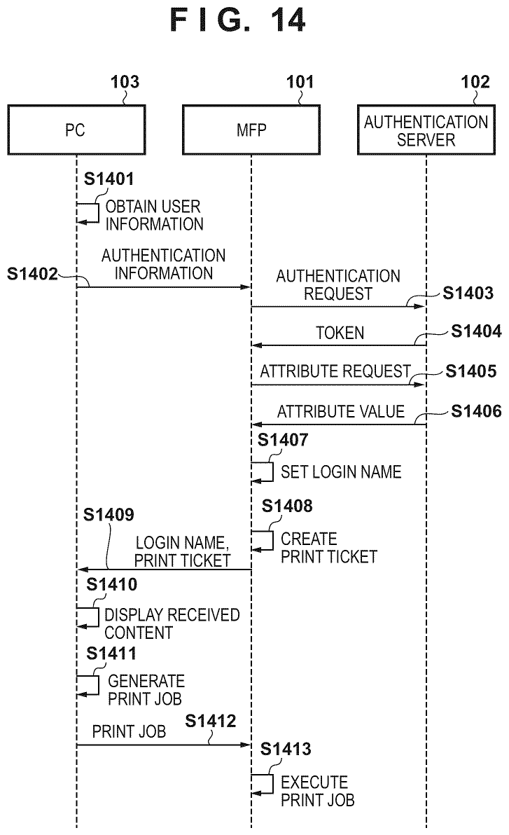

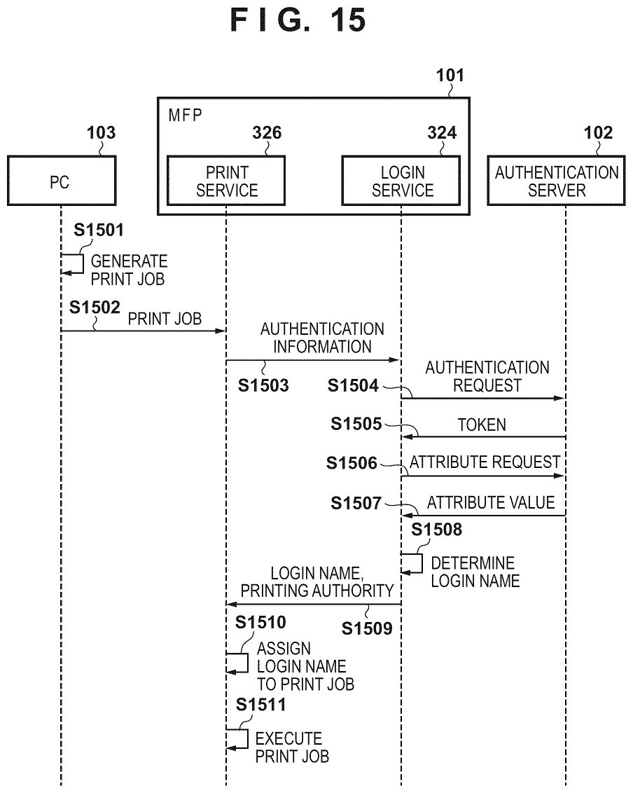

An example of the operations by the system 100 when performing authenticated printing will be described with reference to FIG. 14. Before executing the method of FIG. 14, the user of the PC 103 (referred to simply as the “user” in the description of FIG. 14 hereinafter) may have logged in to the PC 103 locally, or may have logged in to the PC 103 using the authentication server 102. The method illustrated in FIG. 14 may be started in response to the user pressing a button 1305 on the settings screen 1300.

In step S1401, the printer driver 313 obtains the information specified by the user in the input field 1302, the input field 1303, and the pull-down list 1304. This information is used to authenticate the user, and will therefore be referred to as “authentication information”. The authentication information includes the user identifier, the password, and a designation of the authentication server 102 to perform the authentication. In step S1402, the printer driver 313 sends the authentication information obtained in step S1401 to the login service 324 of the MFP 101.

In step S1403, the login service 324 of the MFP 101 requests the authentication server 102 designated by the authentication information obtained in step S1402 to authenticate the user of the PC 103. This request includes the user identifier and password included in the authentication information obtained in S1402. In step S1404, the login service 324 determines whether the authentication is successful based on a response from the authentication server 102. For example, the login service 324 determines that the authentication is successful when an access token is received from the authentication server 102 in response to the request sent in step S1103. The login service 324 determines that the authentication has failed when an error indicating that username or password verification has failed is received from the authentication server 102 in response to the request sent in step S1103. The following will describe a case where the authentication is successful. If the authentication fails, the login service 324 may notify the PC 103 that the authentication has failed.

In step S1405, the login service 324 requests the user attribute value from the authentication server 102, in the same manner as in step S1106 of FIG. 11. In step S1406, the authentication server 102 returns the requested user attribute value. In step S1407, the login service 324 sets the logged-in username, in the same manner as in steps S1107 to S1109 of FIG. 11.

In step S1407, the login service 324 may further determine the role of the user. The login service 324 may determine the role based on the job title (jobTitle) in the user attributes obtained from the authentication server 102. The login service 324 may obtain information on a user group to which the user belongs from the authentication server 102 and determine the role based on the user group to which the user belongs.

In step S1408, the login service 324 determines the printing authority of the user based on the role determined in step S1407, and generates data indicating the printing authority. This data will be referred to as a “print ticket”. As indicated in Table 5 above, if the user is a “General User”, a print ticket is generated which indicates that indicating that color printing, one-sided printing, and 1-in-1 printing is possible. If the user is a “Limited User”, a print ticket is generated which indicates that color printing is prohibited, double-sided printing is possible, and 2-in-1 printing is possible.

In step S1409, the login service 324 sends the logged-in username set in step S1407 and the print ticket generated in step S1408 to the printer driver 313 of the PC 103. The printer driver 313 of the PC 103 stores the logged-in username and the print ticket received from the MFP 101 in the RAM 213 or the HDD 214 of the PC 103 for the subsequent processing.

In step S1410, the printer driver 313 of the PC 103 displays, to the user, the logged-in username and the content of the print ticket received from the MFP 101 in step S1409. For example, the printer driver 313 displays the logged-in username in a region 1306 of the settings screen 1300, and displays the content of the print ticket in a region 1307 of the settings screen 1300. The printer driver 313 may change the printing settings of the printer driver 313 in accordance with the printing authority. The communication by which the printer driver 313 sends the authentication information to the MFP 101 and receives the logged-in username and the print ticket may be performed in a single cycle, or over a plurality of cycles.

In step S1411, in response to obtaining an instruction for the MFP 101 to print from the user, the printer driver 313 of the PC 103 generates a print job in accordance with the instruction from the user. This print job is designated to be executed by the MFP 101. The print job can include print data in a printing format and settings for printing the print data. Furthermore, the printer driver 313 adds the logged-in username and the print ticket received from the MFP 101 in step S1409 to the print job. For example, the logged-in username is set to the owner name of the print job. In step S1412, the printer driver 313 sends the print job to the MFP 101.

In S1413, the print service 326 of the MFP 101 determines whether the print job received in S1412 includes a print ticket. If the print job does not include a print ticket, the print service 326 may cancel the print. However, if the print job includes a print ticket, the print service 326 determines that the user is authenticated, and prints according to the print job. If a hold function is enabled, the print service 326 prints in response to an instruction from the user in the MFP 101. The processing of steps S1401 to S1409 in FIG. 14 described above may be performed each time a printing request from the user is detected, in order to update to the newest information.

Another example of the operations by the system 100 when performing authenticated printing will be described with reference to FIG. 15. In the method illustrated in FIG. 15, the PC 103 includes the authentication information in the print job without obtaining a print ticket. Before executing the method of FIG. 15, the user of the PC 103 (referred to simply as the “user” in the description of FIG. 15 hereinafter) may have logged in to the PC 103 locally, or may have logged in to the PC 103 using the authentication server 102. It is assumed that the authentication information has been set by the user in the settings screen 1300 prior to the method illustrated in FIG. 15 being executed. The method illustrated in FIG. 15 is executed in response to obtaining an instruction to print from the user.

In step S1501, the printer driver 313 of the PC 103 generates a print job in accordance with an instruction from the user. This print job is designated to be executed by the MFP 101. The print job can include print data in a printing format and settings for printing the print data. Furthermore, the printer driver 313 assigns the authentication information set in the settings screen 1300 to the print job. As described above, the authentication information includes the user identifier, the password, and a designation of the authentication server 102 to perform the authentication. In step S1502, the printer driver 313 sends the print job to the print service 326 of the MFP 101.

In step S1503, the print service 326 of the MFP 101 confirms that authentication information has been assigned to the print job received in step S1502. The print service 326 notifies the login service 324 of the authentication information that has been assigned, and requests the logged-in username and the printing authority. In steps S1504 to S1508, the login service 324 sets the logged-in username of the user and determines the printing authority of the user by performing the same processing as that of steps S1403 to S1407 in FIG. 14. In step S1509, the login service 324 returns the determined logged-in username and the printing authority to the print service 326.

In step S1510, the print service 326 assigns the logged-in username obtained in step S1509 to the print job received in step S1502. For example, the print service 326 sets the logged-in username to the owner name of the print job. Instead, however, the print service 326 may manage the print job in association with the logged-in username. In step S1511, the print service 326 prints according to the print job. If a hold function is enabled, the print service 326 prints in response to an instruction from the user in the MFP 101.

In the method of FIG. 15, if the print job received in step S1502 does not include authentication information, or if the authentication requested in step S1504 has failed, the print service 326 cancels the print job.

### Effects of Second Embodiment

According to the foregoing embodiment, the MFP 101 sets the username of the user of the PC 103 based on the authentication information sent by the PC 103 to the MFP 101. This suppresses mismatches in the usernames between the MFP 101 and the PC 103. Additionally, according to the foregoing embodiment, the print service 326 obtains the user identifier used by the authentication server 102 from the OS 311. This saves the user from having to manually input the user identifier.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-083508, filed May 22, 2024, which is hereby incorporated by reference herein in its entirety.

What is claimed is:

1. An image forming apparatus comprising:
a receiving unit configured to receive, from an information processing apparatus, authentication information of a user of the information processing apparatus;
a requesting unit configured to request an authentication server to authenticate the user;
an obtaining unit configured to obtain an attribute value of the user from the authentication server in a case where the user is successfully authenticated by the authentication server; and
a setting unit configured to set a username of the user based on the attribute value in accordance with a setting rule selected from a plurality of setting rules.

2. The image forming apparatus according to claim 1, further comprising:
a sending unit configured to send the username to the information processing apparatus; and
a second obtaining unit configured to obtain a print job having the username.

3. The image forming apparatus according to claim 1,
wherein the receiving unit is configured to receive a print job including the authentication information from the information processing apparatus, and
the image forming apparatus further comprises an assigning unit configured to assign the username to the print job.

4. The image forming apparatus according to claim 1,
wherein each of the plurality of setting rules includes:
a type of the attribute value used to set the username;
a setting pertaining to whether the attribute value is to be processed; and
in a case where the attribute value is set to be processed, a method for processing the attribute value.

5. The image forming apparatus according to claim 4,
wherein the method for processing includes at least one of deleting a character of a specific type from the attribute value, extracting a part before a character of a specific type from the attribute value, and deleting a part exceeding a threshold number of characters from the attribute value.

6. The image forming apparatus according to claim 1,
wherein the plurality of setting rules include:
a first setting rule of setting, as the username, a value obtained by processing a first attribute value obtained from the authentication server; and
a second setting rule of setting, as the username, the first attribute value obtained from the authentication server.

7. The image forming apparatus according to claim 1,
wherein the plurality of setting rules include:
a first setting rule of setting, as the username, a value obtained by processing a first attribute value obtained from the authentication server; and
a third setting rule of setting, as the username, a value obtained by processing a second attribute value obtained from the authentication server.

8. The image forming apparatus according to claim 1, further comprising:
an adding unit configured to add, to the plurality of setting rules, a setting rule created by a user of the image forming apparatus.

9. A method of controlling an image forming apparatus, the method comprising:
receiving, from an information processing apparatus, authentication information of a user of the information processing apparatus;
requesting an authentication server to authenticate the user;
obtaining an attribute value of the user from the authentication server in a case where the user is successfully authenticated by the authentication server; and
setting a username of the user based on the attribute value in accordance with a setting rule selected from a plurality of setting rules.

10. An information processing apparatus comprising:
a sending unit configured to send authentication information of a user of the information processing apparatus to an image forming apparatus;
a receiving unit configured to receive a username of the user from the image forming apparatus; and
an assigning unit configured to assign the username to a print job to be executed by the image forming apparatus.

11. The information processing apparatus according to claim 10,
wherein the authentication information includes a user identifier of the user and a designation of an authentication server to perform authentication.

12. The information processing apparatus according to claim 11, further comprising:
an obtaining unit configured to obtain the user identifier of the user from an operating system of the information processing apparatus.

13. A non-transitory computer readable storage medium having stored therein a program for causing a computer to function as the information processing apparatus according to claim 10.

14. A method for controlling an information processing apparatus, the method comprising:
sending authentication information of a user of the information processing apparatus to an image forming apparatus;
receiving a username of the user from the image forming apparatus; and
assigning the username to a print job to be executed by the image forming apparatus.
